(19) United States
(12) Patent Application Publication
(10) Pub. No.: US 2009/0091477 A1
(43) Pub. Date: Apr. 9, 2009

(54) VEHICLE FOB WITH EXPANDED DISPLAY AREA

(75) Inventors: CLARK E. MC CALL, ANN ARBOR, MI (US); DAVID T. PROEFKE, MADISON HEIGHTS, MI (US); RYAN O'KEEFE, CLAWSON, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/868,821

(22) Filed: Oct. 8, 2007

(51) Int. Cl. G08G 1/123

(52) U.S. Cl. 340/990

(57) ABSTRACT

A multi-mode portable electronic fob and method allows a user to control various vehicle functions and obtain information about the relative location of the vehicle and fob. The information presented to the user can include the vehicle status, vehicle location and/or maps, photos and directions to assist the user in returning to a parked vehicle. The visual information display can share a fob surface with various functional control buttons of the fob or a larger area display can be provided that pulls, folds or swings out from the fob so that the display area is not reduced by the space needed for the control buttons. In a still further embodiment, the display projects the desired information on an available nearby external surface or on a passive screen that extends from the fob. Thus, a larger and a more detailed display image can be obtained.

### TECHNICAL FIELD

The present invention generally relates to a portable apparatus and method for interacting with a vehicle, including providing location information for guiding a user back to the vehicle, and, more particularly, to a multimode portable electronic device and method therefore having an expanded display area.

### BACKGROUND OF THE INVENTION

Portable electronic devices for accessing various vehicle functions (e.g., door lock, unlock, engine start/stop, lights on/off, etc.) are known. Such devices are often referred to as “fobs”, or as “key-fobs” when designed to attach to a key. As is more fully explained later the words “fob” and “keyfob” are intended to include any form of portable electronic device adapted to interact with the user's vehicle, irrespective of whatever additional functions, if any, that it may include, e.g., cell phone, personal digital assistant (PDA), micro-computer, media players, etc.

Many drivers, at one time or another, have experienced difficulty in locating a vehicle that they have previously parked. Malls, airports, and other large venues often have parking lots or garages or tiered parking structures that make losing a vehicle particularly easy and finding a misplaced vehicle particularly challenging. Portable electronic devices have been developed that may help a driver locate a parked vehicle. However, many of these devices depend upon a clear view of position determining satellites or other known position transmitters (e.g., local beacons) that may fail to operate properly in areas where their signal reception is poor or lacking. Unfortunately, such poor reception areas often include locations where vehicles are commonly parked, e.g., parking lots and garages, tiered parking structures, downtown areas surrounded by high-rise buildings, etc. Further, such satellite or beacon based systems may fail to function if the user carries the fob into an office building or other structure where the satellite or beacon signals are no longer clearly received.

There is an ongoing need to provide among other things a multi-mode parked vehicle location system, e.g., a vehicle fob, capable of guiding a user back to his or her vehicle with or without the aid of satellite signals or local beacon signals and that continues to operate even when such signals are not available. A further need is that the information shown to the user be easy to see despite the small size of the fob. This is especially important when the “return to vehicle” directions and/or information are in the form of a detailed map or other multi-element presentation. Accordingly, displays that can be larger than the usual available space on the fob case apart from the fob's function buttons or keys are advantageous. Other desirable features and characteristics of the present invention will become apparent from the subsequent detailed description and the appended claims, taken in conjunction with the accompanying drawings and the foregoing technical field and background.

### SUMMARY OF THE INVENTION

A multi-mode portable electronic fob and method allows a user to control various vehicle functions and obtain information about the relative location of the vehicle and the fob. The information presented to the user can include the vehicle status, vehicle location and/or maps, photos and directions to assist the user in returning to a parked vehicle. The visual information display can be integral with the fob and share a fob surface with various functional control buttons of the fob or a larger area display can be provided that pulls, folds or swings out from the fob so that the display area is not reduced by the space used for the control buttons of the fob. In a still further embodiment, the display projects the desired information on an available nearby external surface or on a passive screen that extends from the fob. Thus, a larger and a more detailed display image can be obtained.

### DESCRIPTION OF THE DRAWINGS

The present invention will hereinafter be described in conjunction with the following drawing figures, wherein like numerals denote like elements, and:

FIGS. 1-5 are plan views of front faces of fobs having a parked vehicle location and other functions in accordance with exemplary embodiments of the present invention and illustrating different modes of operation;

FIG. 6 is a plan view of a rear face of fobs such as those illustrated in FIGS. 1-5, showing further embodiments;

FIGS. 7-10 are perspective views of fobs according to further embodiments of the invention in which the display is extendable, and may be pulled out into viewing position and pushed back into the fob for storage when not needed;

FIG. 11 is a schematic cross-sectional view through a portion of the fob of FIGS. 9-10, according to a still further embodiment, indicating how a flexible display screen is stored on a roller inside the fob in the retracted position;

FIG. 12 is a plan view and FIG. 13 is a side view of a clam-shell type fob according to yet further embodiments of the invention, wherein the display screen is not on the same surface as the fob control function buttons and is concealed and protected in the closed position;

FIG. 14 is a plan view of the clam-shell type fob of FIGS. 12-13 with the portion of the clam-shell containing the display screen in the open position;

FIG. 15 is a plan view of the clam-shell fob of FIG. 14 with the portion of the clam-shell containing the display screen rotated so that the display screen is viewable at the same time as the function buttons of the fob;

FIG. 16 is a plan view and FIG. 17 is a side view of a clam-shell type fob according to still further embodiments of the invention, wherein the display screen is not on the same surface as the fob control function buttons and both the function buttons of the fob and the display screen are concealed and protected in the closed position;

FIG. 18 is a plan view of the clam-shell fob of FIGS. 16-17 with the clam-shell unfolded so that the display screen is viewable at the same time as the function buttons of the fob;

FIG. 19 is a plan view of a fob according to a still yet further embodiment of the invention and having external projection capability for displaying the desired information (e.g., vehicle status, return to vehicle directions or map, etc.) on a nearby wall or other surface external to the fob;

FIG. 20 is a simplified schematic view of an exemplary light path of the projection fob of FIG. 19;

FIGS. 21-24 are simplified perspective views of projection fobs according to additional embodiments of the invention, in which passive retractable display screens are provided onto which the information image is projected;

FIG. 25 is a simplified side view of a projection fob of the type illustrated in FIGS. 21-24, but according to a yet additional embodiment in which the retractable passive display screen is articulated so that it may be tilted up toward the viewer for easier reading;

FIG. 26 is a simplified schematic diagram illustrating an exemplary optical path useful for the fobs of FIGS. 21-25;

FIG. 27 is a block diagram of a vehicle location system that may be incorporated into a portable electronic device, such as the fobs shown in FIGS. 1-19 and 21-25, according to still additional embodiments;

FIG. 28 is a block diagram of a vehicle mounted electronics system adapted to interface with the portable vehicle location system of FIG. 27, according to more embodiments;

FIG. 29 is a flowchart illustrating an exemplary process utilized by the vehicle portion of the vehicle location system shown in FIG. 28 to provide location, photo and/or location quality information to the fob, according to still further embodiments;

FIG. 30 is a flowchart illustrating an exemplary process utilized by the fob portion of the vehicle location system shown in FIG. 27 to receive location, photo and/or location quality information from the vehicle and further process it and present return-to-vehicle information when requested by the user, according to still yet further embodiments of the invention; and

FIG. 31 is a flowchart illustrating an exemplary process analogous to that of FIG. 30, but according to yet still additional embodiments of the invention and showing further detail.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description. For convenience of explanation, the invention is described herein for the case of a fob used to control various aspects of a vehicle. But the invention is not limited to such a device and may be incorporated in portable phones, personal digital assistants (PDA), micro-computers, digital watches, digital audio file players (e.g., MP3 or MP4 players), digital video and/or DVD players, and other portable electronic devices. Accordingly, as used herein, the terms “fob,” “keyfob” and “electronic device” are intended to include these and other portable electronic apparatus adapted to interact with a vehicle, irrespective of whether or not it includes a through-hole for attachment of a key or key-chain, and irrespective of what other non-vehicle related functions it may incorporate. For the purposes of the present invention it does not matter what other electronic functions may be performed by the “fob”, “keyfob” or “electronic device” of the present invention, provided that it incorporates one or more of the various embodiments described herein.

Aspects of the present invention are described in terms of “photos” of the vehicle environment taken automatically or manually. As used herein, the terms “photo”, “photographic” and “image” singular or plural are intended to have their broadest possible meaning and to include but not be limited to any type of graphical representation of a particular location or object or geographical region. Non-limiting examples are maps and images obtained from an electronic camera, either still or in video format, and various translations or modifications of such images as may be performed by image processing, image enhancement, adjustment of clarity or contrast or color, shading, outline or wire-frame processing, and other well known image enhancement techniques to make the images more useful for their intended purpose. As used herein, these and other variations are intended to be included in the terms “photo”, “photographic” and “image”, singular or plural.

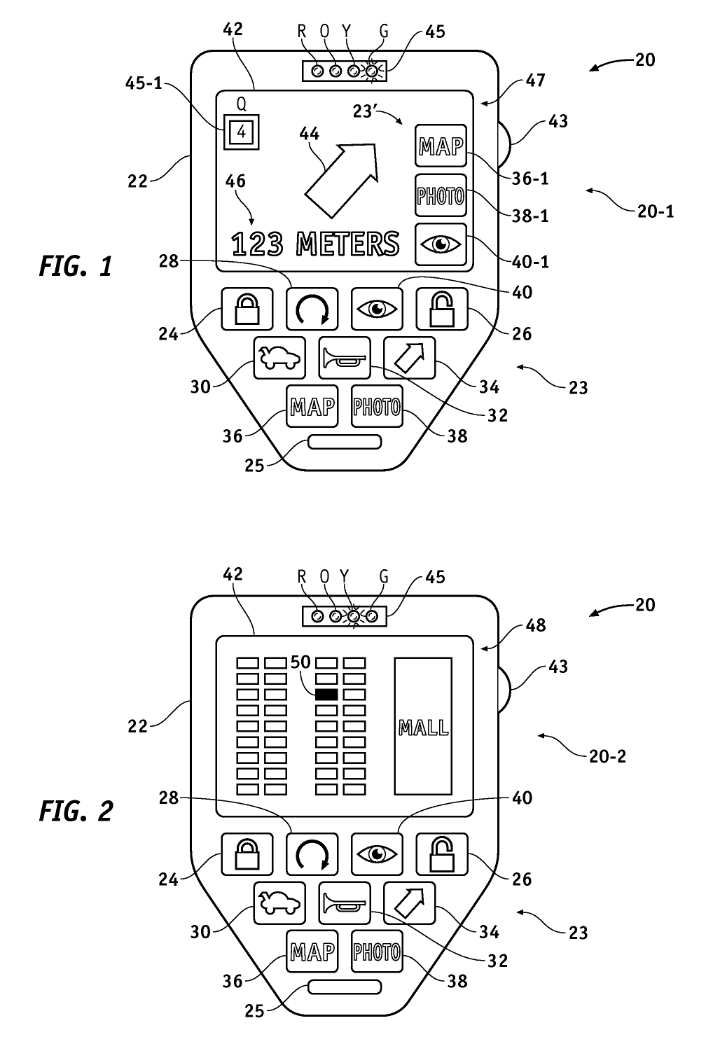

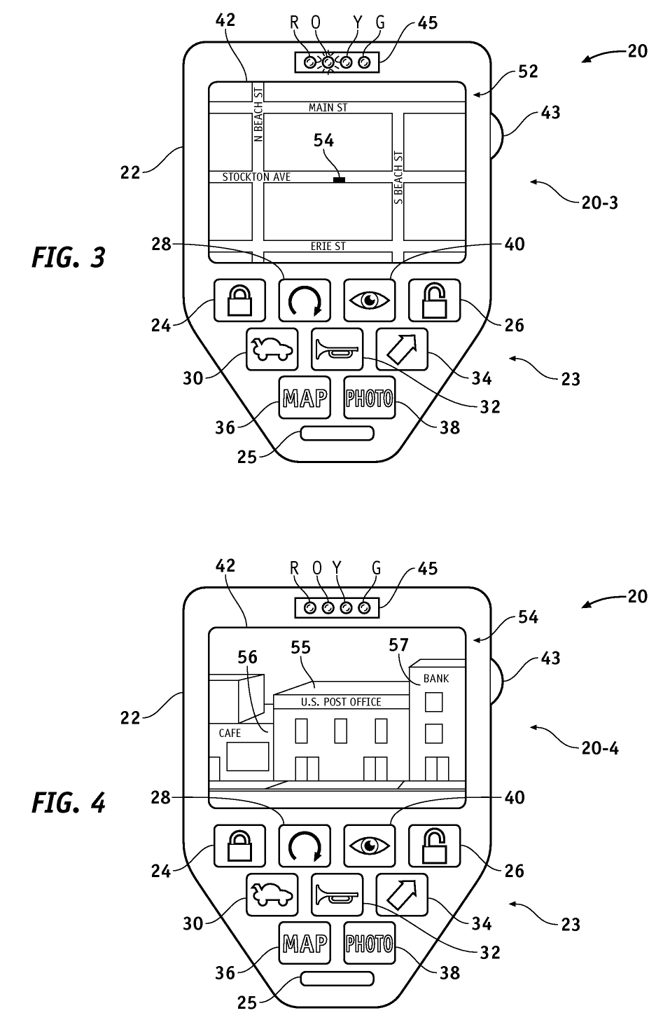

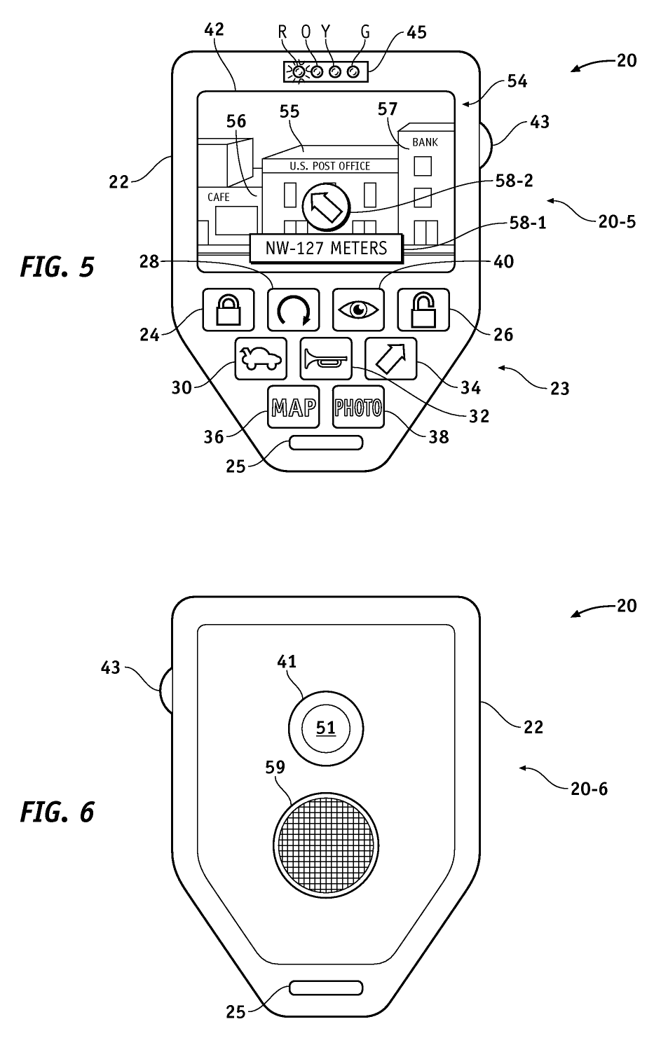

FIGS. 1-6 are plan views of fobs 20-1, 20-2, 20-6, 20-4, 20-5, 20-6 having parked vehicle location and other functions in accordance with various exemplary embodiments of the present invention, wherein the information display is integral with the fob. The convention is adopted of referring to the fobs illustrated in FIGS. 1-6 by the reference number 20-1 for FIG. 1, reference number 20-2 for FIG. 2, reference number 20-3 for FIG. 3, reference number 20-4 for FIG. 4, reference number 20-5 for FIG. 5 and reference number 20-6 for FIG. 6, respectively, and collectively as fob or keyfob 20. FIGS. 1-5 show the same (front) face of fob 20 illustrating various function control buttons or switches and an output display, for different modes of operation. FIG. 6 shows the opposite (rear) face of fob 20 where, according to the embodiment of reference number 20-6, lens 51 of camera 41 is provided so that fob 20 itself can be used to take photos, and annunciator (e.g., loudspeaker, etc.) 59 is also optionally provided. Camera 41 and annunciator 59 may be included on any of fobs 20.

Fob 20 comprises housing 22 having optional opening 25 there through that enables fob 20 to be attached to a key or keychain in the well-known manner. Opening 25 is desirable but not essential. A plurality of control function buttons or other user activated switches 23 are provided on the exterior of housing 22 and may include, for example and not intended to be limiting, DOOR LOCK button 24, DOOR UNLOCK button 26, REMOTE START button 28, TRUNK UNLOCK button 30, PANIC button 32, FIND PARKED VEHICLE buttons 34-38, and optional camera button 40, according to several modes of operation. As used herein, the term “button” is intended to include any form of user operable electronic switch, as for example and not intended to be limiting, a switch whose movement makes or breaks an electrical or optical connection and various forms of proximity switches that make or break an electrical or optical connection when a finger or stylus touches or is brought into close proximity to the switch, and so forth. The term “button” is also intended to include software implemented switches that are activated by contacting a particular region of the display screen, as for example are illustrated by “software buttons” or “screen buttons” 36-1, 38-1, 40-1 shown in FIG. 1. Such “software buttons” or “screen buttons” implemented in a display are well known in the art and intended to be included within the general term “button” for controlling or activating various fob or vehicle control functions. For fobs equipped with an on-board camera, camera shutter button 40, 40-1 is also desirably included. References herein to “depressing a button” are intended to include any means of activating buttons or switches 23 (including screen buttons 23′) and not be limited merely to physical movement of a particular button or switch.

Fob 20 further comprises display 42 (e.g., a liquid crystal or other portable display) that may present status information (not shown) relating to a vehicle (or vehicles) associated with keyfob 20. It is desirable that display 42 be back-lit, as is common for such displays. This status information may include the vehicle's mileage, tire pressure, current fuel level, radio station settings, door lock status, window status, etc., as well as information related to the vehicle location. One or more scroll wheels 43 are conveniently mounted on a side of or other face of housing 22 and utilized to navigate amongst such data and choices, or provide other useful functions (e.g., camera or display focus, etc.). For example, a user may rotate scroll wheel 43 to navigate between vehicular and/or vehicle location features and depress scroll wheel 43 or touch a screen button to select a desired feature and view the information associated therewith. Fob 20 also desirably but not essentially includes light bar 45 with, in this example four LEDs or other colored lights (any number of lights can be used). By way of illustration and not intended to be limiting, the light sources in light bar 45 are identified as showing red (R), orange (O), yellow (Y) or green (G) colors when illuminated. As will be further explained, these lights are useful for providing information to the user on the quality (e.g., accuracy) of the available location information and, as is explained later, can also be used as another means of guiding the user back to a parked vehicle.

When a user depresses any one of FIND PARKED VEHICLE buttons 34-38, fob 20 provides visual prompts on display 42 that may guide the user back to his or her parked vehicle in the manner described below. For example, as indicated in FIG. 1, if FIND PARKED VEHICLE button 34 of fob 20-1 is pressed, then RETURN-TO-VEHICLE information view 47 of arrow 44 may be generated on display 42 indicating the direction of the vehicle relative to the current position of fob 20, if such information is available. In addition, an estimated fob-to-vehicle distance (e.g., 123 meters or other convenient unit) may also be shown on display 42 as illustrated at 46 of keyfob 20-1 of FIG. 1. In a further embodiment, light bar 45 may illuminate to indicate the quality of the location information presented at 44, 46 on display 42 or, for example, on-screen icon 45-1 may be provided to indicate a quality score Q (e.g., Q=4 in FIG. 1) associated with arrow 44 and distance 46 in RETURN-TO-VEHICLE information view 47. In the example of fobs 20, a 0 to 4 quality score or quality scale is used, where a green (G) light on light bar 45 and/or a quality score Q=4 in quality score icon 45-1 indicates the location data quality is excellent. Analogously, if no location information is available, then light bar 45 is dark and icon 45-1 indicates Q=0 or Q=?. If location information is available but its quality is poor (e.g., because of weak GPS or local beacon signals or other reasons) light bar 45 illuminates red (R) and icon 45-1 shows Q=1. If the location information is adequate (e.g., because the GPS S/N ratio is adequate but only 3 satellites or two local beacons can be seen or for other reasons) quality light bar 45 shows orange and quality icon 45-1 would indicate Q=2. If the location information quality is good (e.g., good S/N ratio and 3-4 satellites and/or 3 or more local beacons available or other reasons) then light bar 45 shows yellow (Y) and on-screen icon 45-1 would show Q=3. If the location information quality is excellent (e.g., excellent S/N ratio and more than 4 satellites and/or 4 or more local beacons available or other reasons) then light bar 45 shows Green (G) and on-screen icon 45-1 would show Q=4. The above-mentioned criteria for identifying the various location data quality levels are intended to be merely examples and not limitations. Persons of skill in the art will understand that a wide variety of criteria for determining location information quality can be adopted depending upon the needs of the particular system and the location tracking features incorporated in the system, and that any suitable criteria can be used, including but not limited to those examples presented above.

Referring now to fob 20-2 of FIG. 2, if FIND PARKED VEHICLE button 36 is depressed, overhead view 48 (if available) of the local parking area may be presented on display 42 with the position of the vehicle indicated at location 50. This overhead view can be constructed by manipulating the local environment images acquired by the vehicle as it is being parked, or from images available from an off-board repository, such as a database of satellite images, or from images provided by local cameras in the parking area that are wirelessly transmitted to the vehicle and from the vehicle to the fob or directly to the fob. The generation of this overhead view can occur onboard the vehicle using the vehicle's electronic systems, or generated by a remote server (e.g., a satellite or a local parking facility security system) that wirelessly transfers the processed image to the vehicle for transfer to the fob and/or to the fob directly. Any of these arrangements is useful. In the example of fob 20-2, it assumed that the location information quality is good so that light bar 45 shows yellow (Y). Referring now to fob 20-3 of FIG. 3, when FIND PARKED VEHICLE button 36 is depressed, map view 52 of the local area may be provided with the position of the vehicle indicated at location 54. The map information can be stored in the vehicle as a part of its on-board navigation system or downloaded from a local beacon server or elsewhere. In the example of keyfob 20-3, it assumed that the location information quality is fair so that light bar 45 shows Orange (O).

It will be appreciated that the FIND PARKED VEHICLE location information illustrated in displays 42 of fobs 20-1, 20-2 and 20-3 of FIGS. 1-3, is most conveniently obtained by using navigation information obtained from the vehicle and/or generated within keyfob 20, for example, from GPS or local beacon or node data, combined if necessary with GPS and/or dead reckoning data developed within fob 20, as the user moves away from the vehicle. Such location information can be combined with local map information downloaded from the vehicle into the fob as the user exits the vehicle, to provide the information shown on displays 42 of fobs 20-1, 20-2, 20-3. However, if the vehicle or the fob is unable to receive accurate GPS or local node location information, then the fob may be unable to provide the types of FIND PARKED VEHICLE information displays described above. In that circumstance, a further mode of operation is employed, as illustrated for example, by fob 20-4 of FIG. 4.

Referring now to fob 20-4 of FIG. 4, when FIND PARKED VEHICLE button 38 is pressed, then one or more photos taken from the vehicle before, during or after being parked, is presented on display 42, as is shown, for example, by photo image 54 on display 42 of fob 20-4. In this example, photo 54 shows the front of an easily recognizable nearby landmark, e.g., U.S. Post Office 55 located between café 56 and bank 57, from which the user could readily infer that the vehicle is parked across the street from these buildings. By manipulating scroll wheel 43, for example, other views from the current vehicle location can also be presented, e.g., looking from the sides, from the front, from the back of the vehicle, etc., so as to offer further clues to the vehicle location, that is, where it is parked. As will be subsequently explained, photographs of the vehicle's environment are automatically taken as the vehicle is being parked (and/or just afterward), and then transferred to the fob when the user exits the vehicle, and stored therein for subsequent display when FIND PARKED VEHICLE button 38 is activated. Such photos can also be manually taken at the user's request using the vehicles cameras or a camera within the fob. Under these circumstances where no location quality information is available, light bar 45 is dark, as shown in FIG. 4.

In a further mode of operation according to a further embodiment of the invention wherein the fob includes camera 41 (e.g., see FIG. 6), the fob user may elect to manually take a photo directly with the fob when exiting the vehicle. This insures that a user-chosen, easily remembered, landmark is captured in such a photo. Taking the photo with fobs 20 is accomplished, for example and not intended to be limiting, by pressing button 40, e.g., once to turn on fob camera 41 and a second time to record the photo. When camera 41 is turned on, photo image 54 being seen by fob lens 51 is shown on display 42. Fob lens 51 is conveniently but not essentially located on the opposite face of fob 20 from display 42 and is shown in FIG. 6 and image 54 captured thereby is shown on display 42. As noted earlier, scroll wheel 43 may be used to scan through the various photo images stored in fob 20, whether derived from the vehicle camera(s) or fob camera 41 or both. By rapidly operating or holding down button 40, the user may take a sequence of photos that can be displayed in rapid succession, i.e., like a video.

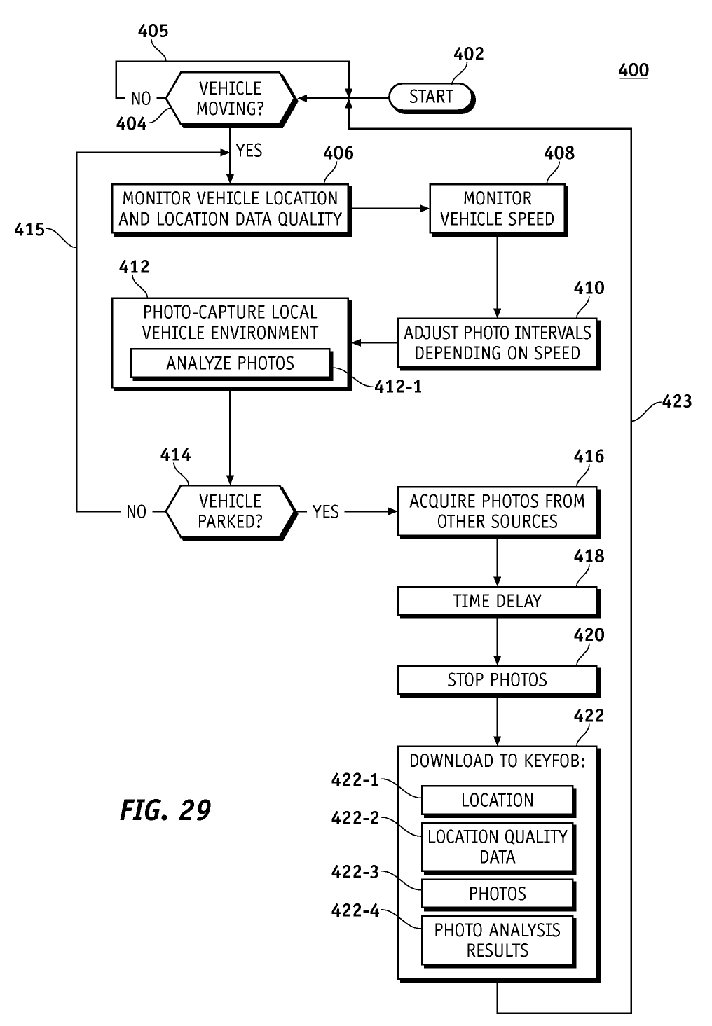

FIG. 5 shows fob 20-5 illustrating another mode of operation of fob 20 that can be activated by, for example and not intended to be limiting, depressing buttons 34 and 38 together, or another button provided particularly for that purpose. In this circumstance, the RETURN-TO-VEHICLE (RTV) location information, e.g., “NW-127 Meters” legend 58-1 and/or directional arrow 58-2, are superimposed on the photo information (e.g., on photo image 54). According to a further embodiment of the invention and depending on the desires of the user, this dual mode of operation may be selected as a preferred mode of operation that is stored within fob 20 so that only a single button need be activated to obtain it. In a still further mode of operation, this dual mode of operation (e.g., location information plus photo information presented at the same time), may be invoked automatically by fob 20 when the quality (e.g., the accuracy) of the location information falls below a predetermined standard. It is well understood, for example, that the quality of GPS or beacon node location information depends upon the number of satellites or beacon nodes that are within range of the GPS navigation system receiver or the beacon node receiver, and the received signal to noise (S/N) ratios. Presentation of combined location information and photo information is explained more fully in connection with FIGS. 29-31. In the example of FIG. 5, the location information quality is assumed to be poor and therefore light bar 45 shows a red (R) light, but this is not essential. On-screen icon 45-1 (see FIG. 1) could also be provided showing, in this example, Q=1.

Fobs 20 of FIGS. 1-6 preferably communicate with the associated vehicle(s) via radiofrequency signals; however, it should be appreciated that other wireless and non-wireless communications means may be utilized as well. For example, including but not limited to, induction-based means, low frequency (e.g., 10-600 kHz) communication means, optical means or a hard-wired connection. A non-limiting example of a hard-wired connection is a fob that carries an electrical connector (e.g., a D-subminiature connector, a multi-pin USB connector similar to that employed by a portable flash drive device, etc.) that permits electrical communication between the fob and the vehicle when the fob is in a docking station in the vehicle. Further, notwithstanding the various example illustrated in FIGS. 1-5 employing visual display 42 adapted to provide graphic images and/or photos, it should be appreciated that other embodiments of fob 20 may utilize other visual indications to guide a user back to the vehicle. For example, light bar 45 may be used as a direction indicator in addition to its function as a quality indicator. In still other embodiments, fob 20 may produce audible signals in addition to or in lieu of visual signals, as for example by means of annunciator 59 of FIG. 6. A non-limiting example of such non-visual signals are spoken directions, e.g., “walk north 100 meters, then west 26 meters, etc., to find the vehicle.” Such audio instructions are conveniently generated based on the fob knowing the location of the vehicle and its current location and calculating the compass directions and distances to return, and/or remembering the directions and distances traveled from the vehicle to reach the current location. Either arrangement is useful.

FIGS. 1-6 illustrate fobs where display 42 shares the same viewed surface as control function buttons 23. As used herein the term “viewed surface” refers to the available surface area of the fob which the user can view in use, usually one relatively flat major surface of the fob. When the function buttons are on the same surface as display 42, then display 42 can only occupy a relatively limited fraction of the total available viewed surface area of fob 20. It is desirable to be able to provide the same functionality in a fob where the display can use substantially the entire viewable surface area of the fob or even larger areas external to the fob.

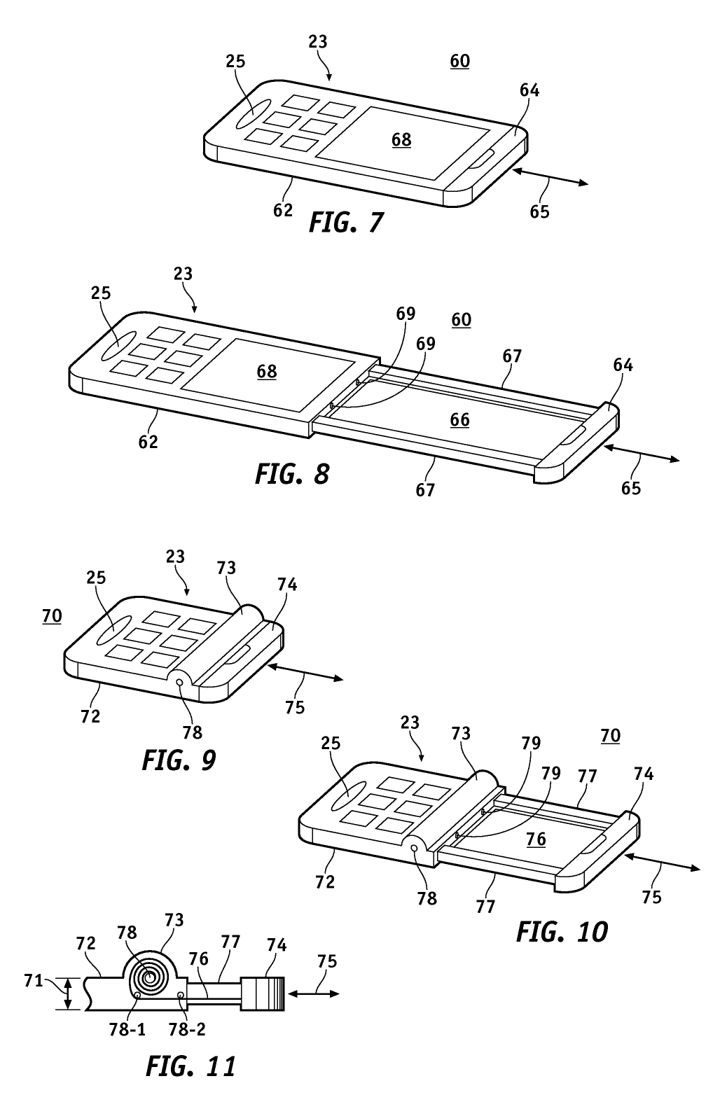

FIGS. 7-10 are perspective views of fobs 60, 70 according to further embodiments of the invention in which display screens 66, 76 are retractable, and may be pulled or otherwise moved out of housing 62, 72 into viewing position and pushed or otherwise retracted back into fob housing 62, 72 for storage when not needed to be viewed. Fobs 60, 70 of FIGS. 7-10 have the advantage compared to fobs 20 of FIGS. 1-6 that display 66, 76 may occupy a substantially larger percentage of the overall viewable surface area of the fob, thereby allowing the user to see greater detail. This is because display 66, 76 need not share the viewable surface area of the fob with function buttons 23.

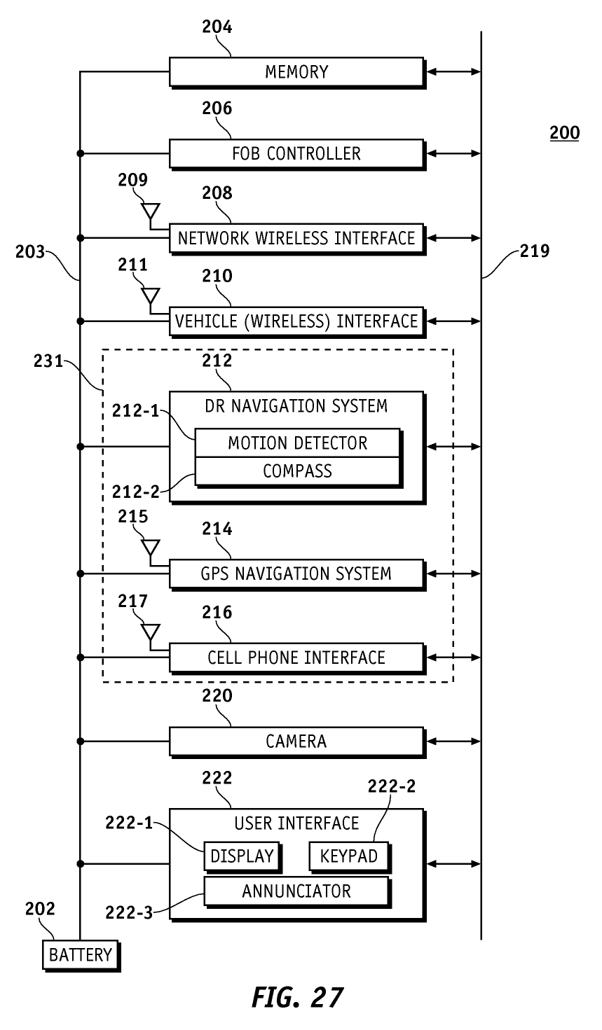

Referring now to FIGS. 7-8, fob 60 comprises housing 62, function buttons 23 and optional key or key-ring attachment opening 25 analogous to housing 22, function buttons 23 and opening 25 FIGS. 1-6. Fob 60 has end portion 64 that may be displaced in the direction of arrow 65 to move display 66 into its exposed position (see FIG. 8) from its normal storage position (see FIG. 7) within housing 62. Side rails 67 are desirably included to provide stiffening and support for display 66. Display 66 is preferably an active display, that is, containing the electrically active pixels that form the desired information image for presentation to the user. In the embodiment of FIGS. 7-8, display 66 may be substantially rigid, since it is not rolled or folded when retracted and stored within housing 62. A liquid crystal display (LCD) is suitable for display 66 but other types may also be used, as for example and not intended to be limiting, OLED (Organic Light Emitting Diode), such as those developed by Universal Display Corporation, Ewing, N.J., and electronic paper displays, such as those developed by E Ink, Corporation, Cambridge, Mass. A back-light may be included on the back side of display 66 to provide night-time visibility of a transmissive type display, otherwise the user may simply hold display 66 up to any available light source, or if the display is of a non-emissive type, it may be illuminated by means of an LED or other source as shown by lights 69 in FIG. 8. OLED displays are light emitting. Window 68 is desirably but not essentially provided in housing 62 so that the portion of display 66 underlying window 68 may be viewed even when display 66 is in its retracted position. When display 66 is of the non-emissive type, an internal light source (not shown) is desirable for illuminating the portion of display visible through window 68. Window 68 is necessarily smaller than display 66 and only the portion of display 66 that underlies window 68 is used when screen 66 is in the retracted position shown in FIG. 7. A switch (not shown) associated with end portion 64 can be conveniently used to instruct the internal electronics in fob 60 (see FIG. 27) to limit the used display area to that underlying window 68 when display 66 is in the retracted position. The arrangement of FIGS. 7-8 provides a display area comparable to that of fobs 20 of FIGS. 1-6 when fob 60 is in the closed position of FIG. 7 and provides a substantially larger display area when screen 66 of fob 60 is extended as shown in FIG. 8. With this arrangement, screen 66 need only be slightly smaller in area than fob 60 itself. This enables fob 60 to present greater detail in a larger area display when such is needed. This is especially useful when detailed map and/or photographic information are to be shown to the user.

Referring now to FIGS. 9-10, fob 70 comprises housing 72, function buttons 23 and opening 25 analogous to housing 22, function buttons 23 and opening 25 of fob 20 of FIGS. 1-6. Fob 70 has end portion 74, analogous to end portion 64 of FIGS. 7-8 that may be displaced in the direction of arrow 75 to move display 76 into its exposed position (see FIG. 10) from its normal storage position (see FIG. 9) within housing 72. Side rails 77 are desirably included to provide stiffening and support for display 76. Fob 70 of FIGS. 9-10 differs from fob 60 of FIGS. 7-8 in that display 76 is a flexible screen that is stored within housing 72 by being wound around spindle 75 when in the retracted position. Lights 79 are desirably included for illuminating display 76 when display 76 is of a non-emissive type.

FIG. 11 is a schematic cross-sectional view through a portion of fob 70 of FIGS. 9-10, indicating how flexible display screen 76 is stored on roller or spindle 75 inside fob 70. Auxiliary rollers 75-1, 75-2 are desirably but not essentially included to assist in flattening display 76 as it is withdrawn from housing 72. By increasing thickness 71 of housing 72 (see FIG. 10), increased height portion 73 to accommodate rolled-up screen 76 may be omitted. Display 76 is preferably an active display, that is, containing the electrically active pixels that form the desired information image for presentation to the user. Examples of flexible displays adapted to be rolled-up around a spindle are OLED displays, such as those developed by Universal Display Corporation, and electronic paper displays, such as those developed by E Ink, Corporation, as noted above. OLED displays emit light themselves, so they do not need back lighting. Electronic Paper Displays do not emit light. Light from the front, e.g., from ambient light or in the dark from lights 79, provides the light for viewing.

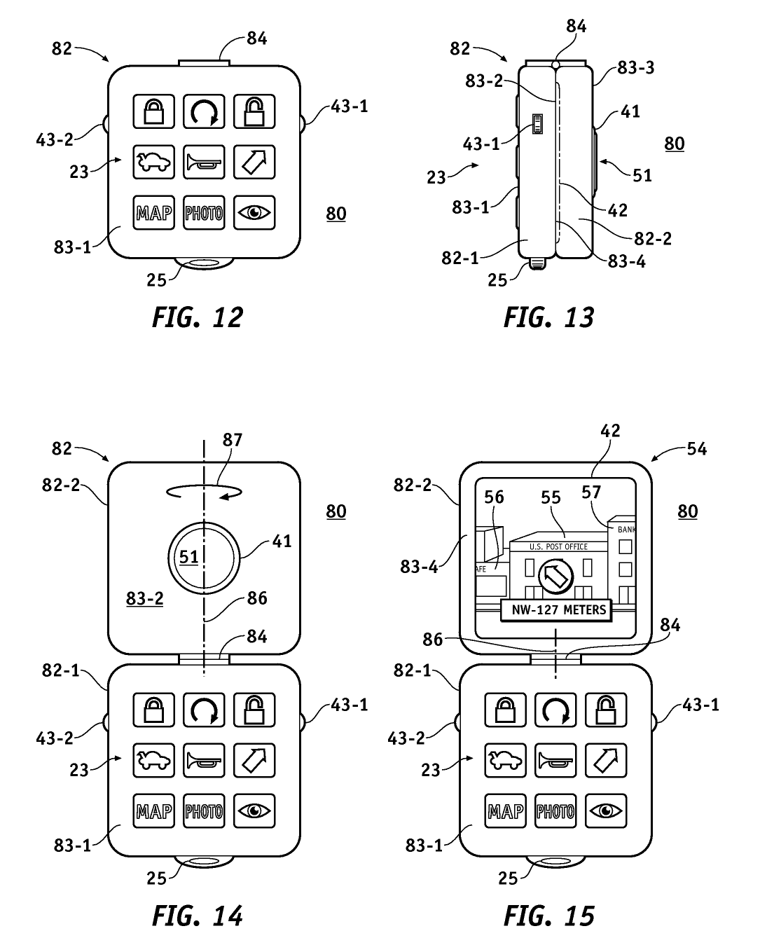

FIG. 12 is a plan view and FIG. 13 is a side view of clam-shell type fob 80 according to yet further embodiments of the invention, and FIGS. 14-15 are plan views of fob 80 when in the open position. Display 42 (see FIGS. 13, 15), analogous to display 42 of FIGS. 1-5, is concealed and protected in the closed position of FIGS. 12-13. Fob 80 has housing 82 with upper portion 82-1 and lower portion 82-2 joined by hinge 84. Function buttons 23 are located in surface 83-1 of portion 82-1. Optional camera 41 with lens 51 is conveniently but not essentially located on surface 83-3 of portion 82-2 and display 42 analogous to display 42 of FIGS. 1-5 is located on surface 83-4 of portion 82-2 so that it is facing toward surface 83-2 of portion 82-1 and protected in the closed position. Having function buttons 23 exposed in the closed position makes them readily available to the user for vehicle control functions that do not require information to be presented on display 42, e.g., LOCK, UNLOCK, ENGINE START, LIGHTS ON/OFF, etc. In the configuration of FIG. 13, surfaces 83-2 and 83-4 are facing inner surfaces and surfaces 83-1 and 83-3 are exterior surfaces.

When fob 80 is opened by rotating portion 82-2 relative to portion 82-1 around hinge 84 as shown by arrow 85, screen 42 on surface 83-4 is initially facing away from the user and function buttons 23. Portion 82-2 is then rotated around axis 86 as shown by arrow 87 (see FIGS. 14-15) so that display 42 on surface 83-4 is brought approximately into the orientation of FIG. 15 so as to be viewable at the same time as function buttons 23, i.e., surfaces 83-1 and 83-4 now face in the same direction. In the example of FIG. 15, image 54 is shown on display 42 as has been already described in connection with FIG. 5. In this configuration, the area of display 42 can be nearly as large as the fob itself. This is a significant advantage when presenting detailed information that benefits from a larger display format and/or for providing a minimum size fob with a maximized display.

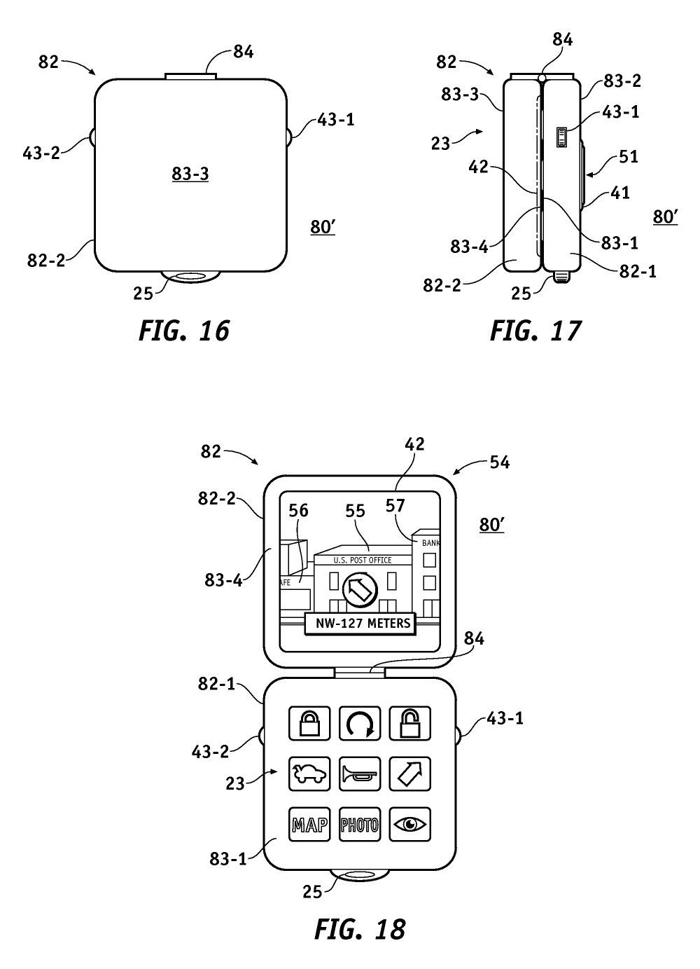

In a further implementation illustrated in FIGS. 16, 17, 18, analogous to FIGS. 12, 13, 14 respectively, and referred to as clam-shell fob 80′, the initial relative position of portions 82-1 and 82-2 are reversed so that surface 83-1 with function buttons 23 and surface 83-4 with display 42 are facing each other in the closed position. Then when the clam-shell is opened (i.e., rotated around hinge 84), surfaces 83-1 and 83-4 face in the same direction (see FIG. 18) and a second rotation around axis 86 of FIGS. 14-15 is not needed. With this arrangement it is advantageous to place lens 51 of camera 41 on surface 83-2 of housing portion 82-1 but this is not essential. With the configuration of FIGS. 16-18, clam-shell fob 80′ must be opened to access function buttons 23. In the configuration of FIG. 17, surfaces 83-1 and 83-4 are inner facing surfaces and surfaces 83-2 and 83-3 are exterior surfaces.

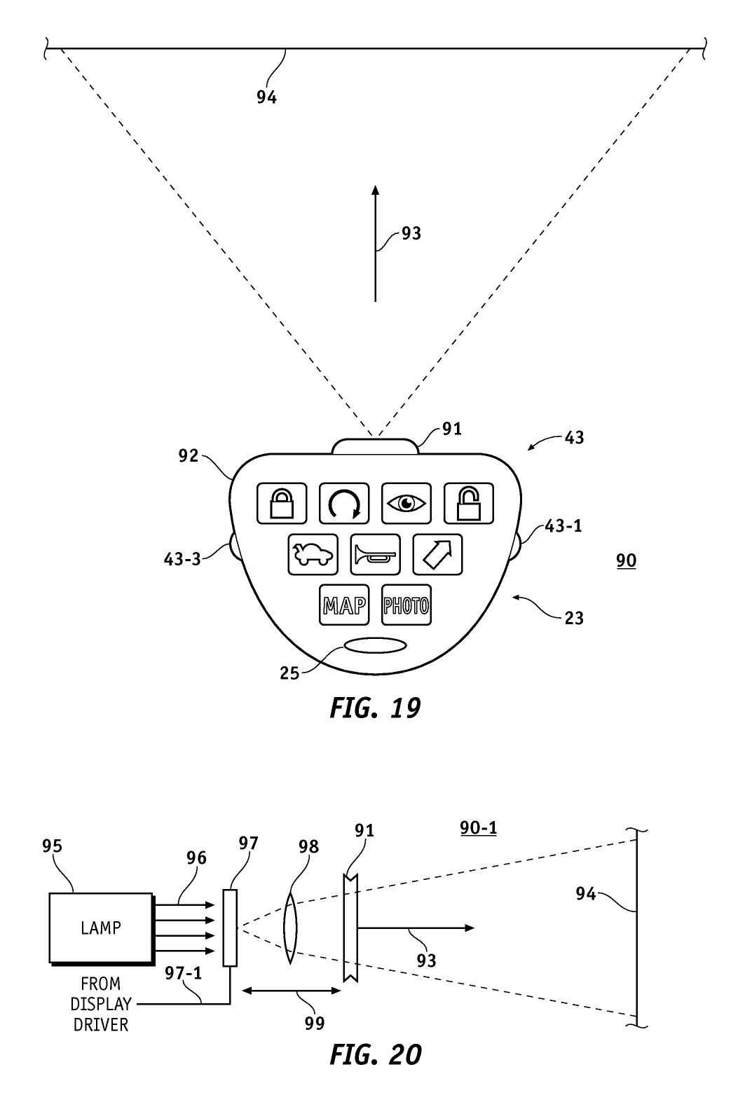

FIG. 19 is a plan view of fob 90, according to still yet further embodiments of the invention, having external projection lens or window 91 for displaying desired information image 93 (e.g., vehicle status, return to vehicle directions or map, etc.) on nearby wall 94 or other surface external to fob 90. Fob 90 comprises external housing 92, functions buttons 23, key or keychain opening 25 and one or more scroll wheels 43 (e.g., 43-1, 43-2) analogous to housing 22, buttons 23, opening 25 and scrolls wheel(s) 43 of FIGS. 1-6.

FIG. 20 is a simplified schematic view of exemplary light path 90-1 within projection fob 90 of FIG. 19. Exemplary light path 90-1 comprises lamp 95 (light emitting diodes (LED's) are preferred) for producing illumination 96, transmission type display panel (e.g., and LCD) 97 that is coupled via signal connections 97-1 to the display driver within user interface 222 of FIG. 27, and focusing lens 98, that may be moved relative to display panel 97 as indicated by arrows 99. Display panel 97 modulates light 96 so as to produce image 93 that is projected through window or lens 91 onto external surface 94. Light path 90-1 is conveniently a substantially straight optical path, that is, it is not significantly off-set or laterally displaced, as is for example optical path 140 of FIG. 26, although that is not precluded. Surface 94 may be a nearby wall or floor or the side of a large handbag, briefcase or notebook or any other relatively flat surface external to the fob. While schematic light path 91-1 of FIG. 20 shows only single lens 98 and optical window 91, persons of skill in the art will understand that multiple lenses may be used and that window 91 may also act as a lens, depending upon the needs of the designer. The focusing action indicated by arrows 99 may be a factory setting for a fixed focus device or coupled to one or the other of scroll wheels 43 (see FIG. 19) for a user variable type of device. Either arrangement is useful.

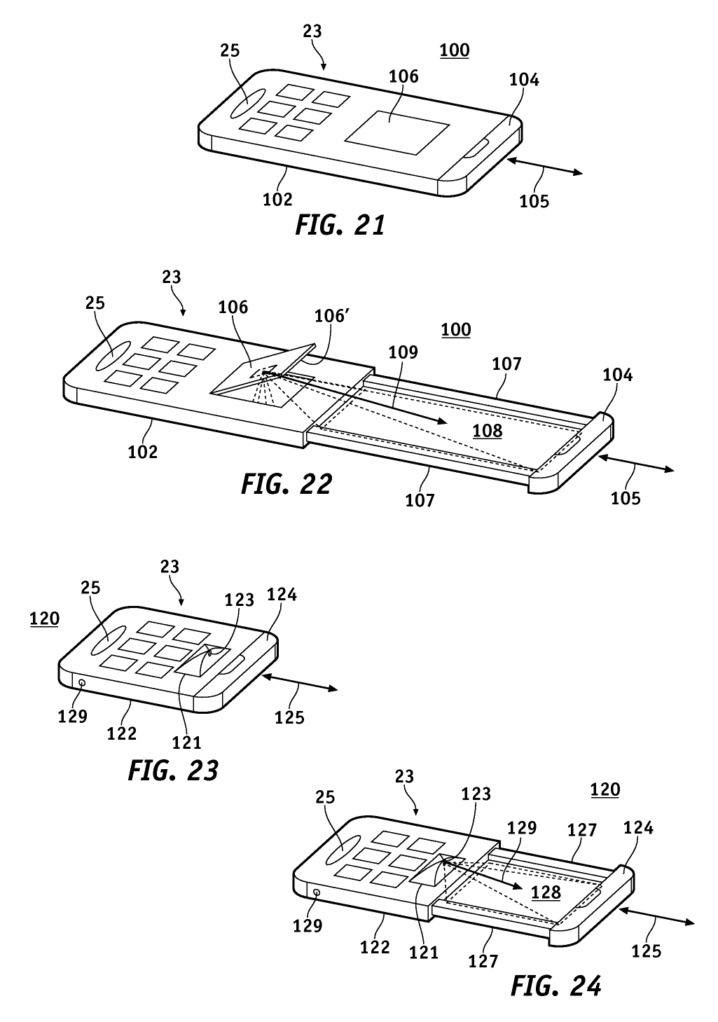

FIGS. 21-24 are simplified perspective views of projection fobs 100, 120 according to yet still further embodiments of the invention, in which passive retractable display screens 108, 128 are provided onto which information image 109, 129 is projected. Screens 108, 128 are passive, that is, they need not contain any active display elements but merely function as reflective surfaces onto which images 109, 129 are projected from within fobs 100, 120. Fobs 100, 120 comprise housings 102, 122, function buttons 23 and key or keychain attachment openings 25, analogous to housings 22, buttons 23 and openings 25 of fobs 20 of FIGS. 1-6. Fobs 100, 120 further have end portions 104, 124 that allow screens 108, 128 to be extended from and retracted into fobs 100, 120 as shown by arrows 105, 125. Fobs 100, 120 differ in the relative size of fobs 100, 120 and screens 108, 128, the manner in which images 109, 129 are projected onto screens 108, 128 and the nature of the screens themselves. FIGS. 21-22 illustrate an arrangement wherein screen 108 may be a rigid screen in that it need not be folded or rolled up when retracted within housing 102. FIGS. 23-24 illustrate an arrangement wherein screen 128 is a flexible screen that is stored within fob 120 by being rolled-up around spindle 129 (analogous to spindle 78 of FIG. 11) when in the retracted position. Side-rail stiffeners 107, 127 are desirably provided with fobs 100, 120 to facilitate support of screens 108, 128. Referring now to FIGS. 21-22, fob 100 further has trap-door like feature 106 that is closed when screen 108 is in the retraced position, but which pops up when screen 108 is extended. Lower surface 106′ of trap-door 106 is desirably reflective so that the information image 109 generated within fob 100 (see FIG. 26) is projected onto screen 108. A prism may also be used in place of reflective lower surface 106′ of trap-door 106. Referring now to FIGS. 23-24, fob 120 has permanently located projection housing 121 with exterior lens or window 123 through which image 129 generated within fob 120 (see FIG. 26) is projected onto screen 128 when it is in the extended position. Trap door feature 106 and permanent projection housing 121 may be used with either rigid screen 108 of fob 100 or with flexible screen 128 of fob 120. Either combination is useful. Those function buttons of fobs 100 and 120 that do not require presentation of image information 109, 129 to the user are active even when screens 108, 128 are in the retracted position. This is convenient. The “return-to-vehicle” function buttons that require presentation of image information 109, 129 to the user, become active when screens 108, 128 are moved to the extended position as shown by arrows 105, 125.

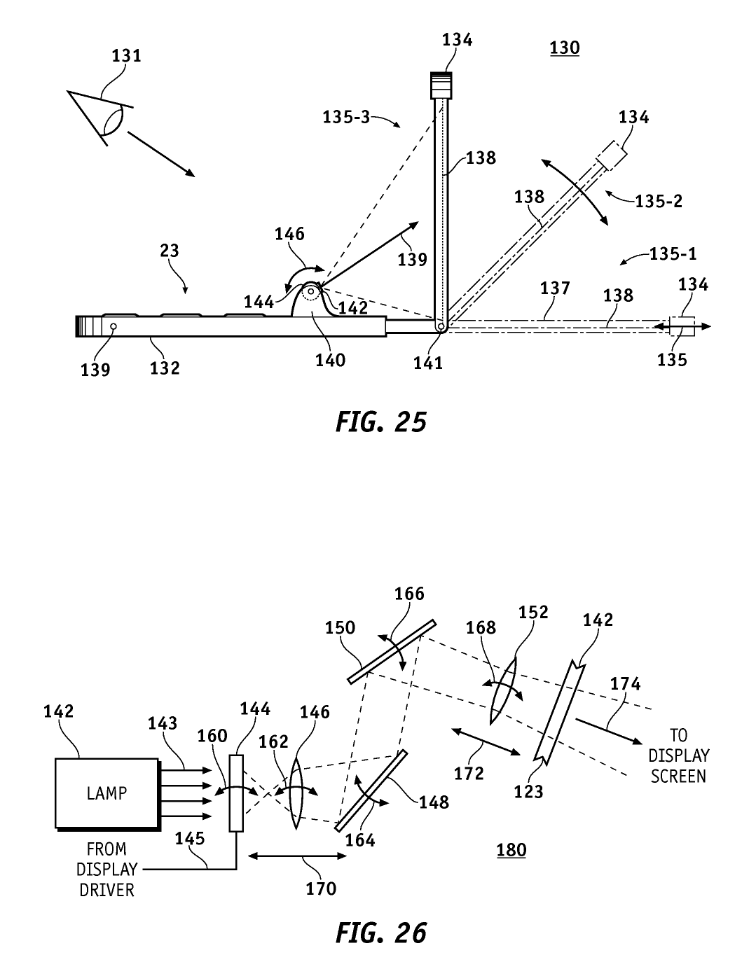

FIG. 25 is a simplified side view of projection fob 130 of the type illustrated in FIGS. 21-24, but according to an additional embodiment of the invention in which retractable passive display screen 138 is articulated so that it may be tilted up toward viewer 131 for easier reading. Screen 138 may be of a rigid type or of a flexible type that is rolled up around spindle 139 when retracted. Fob 130 comprises housing 132, function buttons 23, end portion 134, side rails 137 analogous to those previously described in connection with FIGS. 21-24, and pivot 141 that allows extended screen 138 to be moved from initial pull-out position 135-1, to tilted-up position 135-2 and/or to fully up-right position 135-3 toward viewer 131. Projection housing 140 with external lens or window 142 is provided on housing 132 so that image 139 generated within housing 132 (see FIG. 26) may be directed toward screen 138. In a further embodiment, head 144 of housing 140 containing external optical window or lens 142 may be moveable as shown by arrow 146 so as to facilitate projection of image 139 onto screen 138 for different positions 135-1, 135-2, 135-3, etc., of screen 138.

Referring now to FIG. 25 and FIGS. 8 and 10, persons of skill in the art will understand based on the description herein that the articulated configuration of FIG. 25 can also be used with direct view displays 66 and 76 of FIGS. 8 and 10. That is, displays 66 and 76 can be articulated around a pivot analogous to pivot 141 of FIG. 25 so as to be able to tilt toward viewer 131 in the same way as display 138 of FIG. 25. With this embodiment, then projection housing 140 is omitted since displays 66, 76 are of a direct view type.

FIG. 26 is a simplified schematic diagram of optical path 180 suitable for use in connection with fobs 100, 120, 130 of FIGS. 21-25. Optical path 180 comprises lamp 142, e.g., one or more light emitting diodes (LEDs), providing light 143, transmissive (e.g. LCD) display panel 144 coupled to a display driver within user interface 222 (see FIG. 27) via link 145, which modulates light 143 to produce optical image 174 that is coupled to a display screen (e.g., screen 108, 128, 138) exterior to fob 100, 120, 130 via lenses 146, 152 for focusing and enlarging image 174 and mirrors or prisms 148, 150 for offsetting the direction of propagation of image 174. External optical window 123, 142 (see FIGS. 24, 25, 26) through which image 174 passes may be separate from or integral with lens 152. Arrows 160, 162, 164, 166 168 indicate that the lenses and mirrors (or prisms) may be set at various angles to facilitate the presentation geometry of image 174 and arrows 170, 172 indicate that focusing and enlargement of image 174 may be accomplished by changing the position of lenses 146, 152, as is conventional. While two lenses and two mirrors (or prisms) are shown in optical path 180, persons of skill in the art will understand that more or fewer optical elements may also be used. Light path 141 has a substantially offset or laterally displaced optical path, as compared, for example, to optical path 90-1 of FIG. 20. Stated another way, optical path 180 provides significant lateral displacement of the optical path in a direction normal to its principal direction of propagation. Image 174 of FIG. 26 corresponds to images 109, 129, 139 of FIGS. 22, 24, 25.

Referring to FIGS. 20-26, it will be understood that optical images 93, 109, 129, 139, 174 provide a larger area image on presentation screens 94, 108, 128, 138 than the area of transmissive display 97, 144 used to form images 93, 109, 129, 139, 174. Stated another way, projection fobs 90, 100, 120, 130 enlarge the informational image being presented to the user compared to the display element used to form the image. This is in contrast to fobs 20, 60, 70, 80, 80′ wherein display 42, 66, 76 used to form the information image is intended for direct view without substantial optical enlargement. However, nothing precludes a designer or user placing an optical magnifying panel over displays 42, 66, 76 to enlarge all or some portion of the image information thereon.

FIG. 27 is a block diagram of vehicle location and control device 200 adapted to be incorporated into a portable electronic device, such as fobs 20 shown in FIGS. 1-6, fobs 60, 70 shown in FIG. 7-10, fobs 80, 80′ shown in FIGS. 12-18, fob 90 shown in FIG. 19 and/or fobs 100, 120, 130 shown in FIGS. 21-25. Various subsets or all of the elements illustrated in FIG. 27 may be incorporated in various embodiments of the invention, depending upon the functions desired to be included in any of the fobs identified above. System 200 comprises battery 202 for supplying electrical power via power bus 203 to various elements 204-222 of device 200. As used herein, the term “battery” is intended to include any sort of portable electrical energy source, as for example and not intended to be limiting, chemical cells, fuel cells, storage capacitors, solar cells, thermoelectric generators, mechanical generators, nuclear powered cells, and combinations thereof. Battery 202 may include a power conservation capability (not shown) that disconnects various elements of device 200 when not in use. This is desirable but not essential.

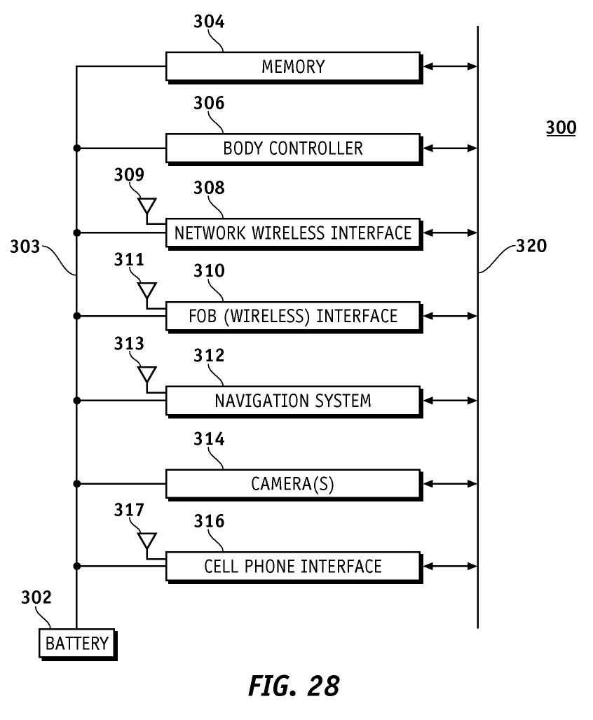

Device 200 comprises memory 204 in which resides the software for operating device 200 as well as data downloaded from the vehicle and/or local beacons or satellites, and other data generated within device 200. Memory 204 desirably has non-volatile and volatile portions for long term and transient storage of information and data. Device 200 further comprises: fob controller 206 that manages the operation of device 200; optional network wireless interface 208 with antenna 209 for communicating with an external network as for example and not intended to be limiting, a network of local nodes; vehicle interface 210 (with antenna 211 when interface 210 is a wireless interface) for communicating with the related sub-system (see FIG. 28) located in the vehicle and by which location information, map information, photos, etc., may be downloaded from the vehicle to the fob; optional dead reckoning (DR) navigation system 212 incorporating for example and not intended to be limiting, motion detector 212-1 and electronic compass 212-2 for determining the current location of the fob based on a known starting point (e.g., the parked vehicle location) and movement tracking using the motion detector and compass; optional GPS navigation system 214 with antenna 215 adapted to receive signals from various GPS satellites from which the current position of the fob can also be determined; optional cell phone interface 216 with antenna 217 adapted to utilize available local cell-phone sites for determining the position of the fob; optional camera 220 (analogous to camera 41 of FIGS. 6, 13, 17) for photographing the local environment, and user input-output (I/O) interface 222 comprising, for example, one or more displays 222-1 analogous to display 42, 66, 76, 97, 144 described herein and associated display drivers (not shown), keypad or other user activated input devices 222-2, for example, analogous to buttons 23 described herein, and annunciator 222-3. Annunciator 222-3 (analogous to annunciator 59 of FIG. 6) may include both audible and/or visual indicators (e.g., a loudspeaker, buzzer, one or more flashing lights such as in light bar 45, etc.). Elements 204-222 are coupled via signal bus 219. Device 200 is illustrated as using serial bus 219 for coupling elements 204-222 that exchange, send or receive information, but persons of skill in the art will understand that the invention is not limited merely to systems employing a serial bus and that the various elements 204-222 may be coupled in other ways, as for example and not intended to be limiting, by parallel connections to fob controller 206 or a combination of serial and parallel connections. Antennas 209, 211, 215, 217 may each be single antennas or a plurality of antennas or an array of distributed antennas, depending upon the vehicle and desired antenna configuration. User interface 222 of FIG. 24 may comprise any indication means suitable for providing a user with information useful in locating a parked vehicle or receiving other desired information. Similarly, vehicle interface 210 may comprise any device suitable for receiving data from a vehicle indicative of the vehicle's location including the photographs previously described. For example, interface 210 may comprise a wireless transceiver, such as an RF transceiver having antenna 211 adapted to operate at a desired frequency. Frequencies at or around 615 MHz and 464 MHz can be used for this purpose but are not essential. Alternatively, interface 210 may be a wired interface wherein the fob plugs into a docking station in the vehicle.

Network wireless interface 208 with antenna 209 is configured to receive signals broadcast by nearby wireless network nodes (e.g., local beacons having known locations), and to provide related signals to controller 206. To this end, controller 206 and network interface 208 may be configured in accordance with common compatibility standards for wireless local area networks (e.g., Wi-Fi standards) or for personal area networks (e.g., Bluetooth standards). In certain exemplary embodiments, controller 206 and network interface 208 may be configured in accordance with low data transmission rate networks (e.g., IEEE 802.15.4, such as a Zigbee network). Such low data rate standards have a data transmission rate slower than that of Wi-Fi or Bluetooth standards (e.g., 250 Kbps at 2.4 GHz), but consume relatively little power and thus may help prolong the life of battery 202. For this reason, adapting controller 206 and network wireless interface 208 to operate at low data transmission rate standards may be especially desirable in embodiments wherein battery 202 is not frequently recharged.

As indicated above, dead reckoning (DR) navigation system 212 may include motion detector 212-1. Motion detector 212-1 may comprise any movement-sensitive device. For example, motion detector 212-1 may comprise a circular spring mounted concentric to a pin or wire that passes freely through the center of the circular spring. When motion detector 212-1 experiences any significant amount of motion, the spring deflects and touches the pin or wire to complete an electrical circuit. When the motion stops, the surrounding spring returns to its quiescent state wherein the pin or wire is not contacted. Such motion detectors are well-known in the art and desirable for use in conjunction with subsystem 200 due to their modest power requirements.

To measure traveled distance, DR navigation system 212 may utilize motion detector 212-1 such as a pedometer or multi-axis accelerometers; that is, DR navigation system 212 may utilize a motion detector to measure the number of steps taken by a user. To estimate the direction traveled, DR navigation system 212 usefully further employs a compass, such as electronic compass 212-2. Utilizing information provided from DR navigation system 212 relating to distance and direction of movement, controller 206 may estimate the location of the fob relative to a reference point (such as the parked vehicle location) in the well-known manner.

In certain embodiments, vehicle location system 200 may include a conventional GPS navigation system 214 with antenna 215. When able to receive satellite signals of sufficient quality, GPS navigation system 214 may be utilized to determine the location of the fob. However, in the absence of GPS data, subsystem 200 may determine its location by reference to node location data provided by one or more wireless network nodes as described above. Elements 212, 214, 216 are collectively referred to as tracking system 231 and it should be understood that tracking system 231 can include any combination or subset of elements 212, 214, 216.

FIG. 28 is a block diagram of vehicle mounted electronics device 300 adapted to interface with portable vehicle location device 200 of FIG. 27 incorporated in fobs 20 of FIGS. 1-6, fobs 60, 70 of FIG. 7-10, fobs 80, 80′ of FIGS. 12-18, fob 90 of FIG. 19 and/or fobs 100, 120, 130 of FIGS. 21-25. Device 300 is also referred to as the vehicle portion of the overall vehicle-fob system. Device 300 is installed in the vehicle and comprises battery or other energy source 302 which is coupled to the various elements of device 300 via power bus 303. Device 300 comprises memory 304 in which resides the software for operating device 300 as well as data to be downloaded to device 200 of the fobs. Memory 304 desirably has non-volatile and volatile portions for long term and transient storage of information and data. Device 300 further comprises: body controller 306 which manages the operation of device 300 as well as other functions within the vehicle normally referred to as the body electronics; optional network wireless interface 308 with antenna 309 for communicating with an external network as for example and not intended to be limiting, a network of local nodes including security cameras and photographic satellites; keyfob interface 310 (with antenna 311 in the case of a wireless interface) for communicating with related device 200 located in the fob and by which location information, map information, photos, etc., may be downloaded from the vehicle to the fob; navigation system 312 incorporating for example a GPS navigation receiver with antenna 313 (or any other form of position determining devices) adapted to receive signals from various GPS satellites from which the current position of the vehicle can be determined for subsequent transmission to the fob via interface 310; one or more cameras 314 for obtaining views of the parked vehicle environment, as for example, ahead, to the sides, to the rear of the vehicle, etc.; and optional cell phone interface 316 adapted to utilize available local cell-phone sites for determining the position of the vehicle. Cell phone interface 316 may include antenna 317 or may merely couple to a separate cell phone system elsewhere in the vehicle. Either arrangement is useful. Navigation system 312 may also include a dead reckoning (DR) navigation system that operates in combination with a GPS receiver to fill in gaps in GPS coverage or operates independently thereof, according to the desires of the system designer. Signal bus 320 generally extends to other vehicle sub-systems (not shown) so that controller 306 can, in response to commands from fob system device, lock or unlock the vehicle, start the engine, unlock the trunk, raise or lower the windows, report on the status of various vehicle sub-systems, and so forth. The elements illustrated in device 300 are generally those that are useful for interaction with device 200 of FIG. 27 and the various fobs described herein for providing RETURN-TO-VEHICLE information. Other well known vehicle electronics elements are omitted to avoid obscuring the invention. Antennas 309, 311, 313, 317 may each be single antennas or a plurality of antennas or an array of distributed antennas, depending upon the vehicle and desired antenna configuration.

FIG. 29 is a flowchart illustrating exemplary process 400 utilized by vehicle portion 300 of FIG. 28 of the vehicle location system, to provide location and/or photo information to the various fobs described herein. Process 400 begins with START 402, which may occur when the ignition is turned ON. Initial query 404 is provided to determine if the vehicle is moving. If the outcome of query 404 is NO (abbreviated as “N”) then method 400 returns to START 402 as shown by pathway 405. If the outcome of query 404 is YES (abbreviated as “Y”), then method 400 proceeds to MONITOR VEHICLE LOCATION AND LOCATION DATA QUALITY step 406 and subsequent steps. In step 406 data is collected regarding the vehicle location and the accuracy and completeness of the collected vehicle location information, for example and not intended to be limiting, the number of GPS satellites in use by the location monitoring system as the vehicle is parking, satellite signal strength, a list or a summary of the local beacons encountered, an estimate of the uncertainty of the location information (e.g., horizontal information is accurate to +/−20 meters, altitude information is accurate to +/−1 meter, or such other numbers as the case may be, etc.). The quality of the location data will depend upon the number of satellites and/or local nodes that can be seen by vehicle navigation system 312 (see FIG. 28) and the signal to noise ratios of the received signals. It is up to the system designer to determine what level of location information confidence is deemed to be “adequate” and how it should be scored or rated (e.g., Q=0 to 4) as illustrated earlier or using some other scale, depending upon the overall system performance criteria that the designer has adopted and how this information should be assessed by or presented to the user.

Following step 406, method 400 desirably but not essentially proceeds to MONITOR VEHICLE SPEED step 408 wherein information on the current vehicle speed (S) is desirably captured. The vehicle speed S information obtained in step 408 is desirably but not essentially used in step 410 to adjust the interval at which vehicle cameras 314 (see FIG. 28) snap photos of the vehicle environment. For example, if the speed S is at or above magnitude S1 (e.g., about 5 miles per hour (MPH)), the photo interval τ is adjusted so that in PHOTO CAPTURE step 412, photos of the environment around the vehicle are taken about once every τ1 seconds (e.g., τ1˜5 seconds). If the speed is less than S1, then the photo interval is reduced to interval τ2<τ1 wherein, for example, the photos are taken once every τ2 seconds (e.g., τ2˜1 second). Larger or smaller values of τ1 and τ2 can also be used. Having τ2<τ1 has the advantage of providing more photographs of the vehicle surroundings as it slows and parks. In step 412, cameras 314 (see FIG. 28) photograph the vehicle environment (e.g., ahead, to the sides, behind, etc.). This process occurs while the vehicle is still moving and as the vehicle slows and after it stops.

Method 400 proceeds to VEHICLE PARKED? query 414 or first to ANALYSE PHOTOS step 412-1 and then to query 414. In step 412-1 the photos taken in step 412 are optionally analyzed, for example using pattern recognition techniques, to extract, for example, and not intended to be limiting, alpha-numeric information such as name(s) of the parking structure or building where the vehicle has entered, parking slot identifiers where the vehicle is parked, and other images of interest for location identification purposes. This is desirable but not essential. According to further embodiments, it is desirable to analyze a sequence of photos for the time period immediately preceding the vehicle coming to a “parked” condition, so that, for example, the name of the parking structure and the parking slot or stall that the vehicle has entered may be captured. It may also be advantageous in still further embodiments to record images with varying fields of view. For example, a short focal length lens could provide desirable content that would not be available from a long focal length image, i.e., more contextual information; and/or a long focal length lens may provide a less distorted image of a specific item, i.e., a “parking area 15E” location sign. Step 412-1 may be performed any time prior to step 422. The photos obtained in step 412 are taken using cameras 314 of FIG. 28. Operation of cameras 314 is controlled by body controller 306 and the photos captured in step 412 and analyzed in step 412-1 are stored in memory 304 of FIG. 28.

In VEHICLE PARKED? query 414 it is determined whether or not the vehicle has come to a stop and, optionally, the transmission placed in “park.” If the outcome of query 414 is NO, then, as shown by path 415, method 400 returns to MONITOR VEHICLE LOCATION AND LOCATION DATA QUALITY step 406. If the outcome of query 414 is YES, then method 400 advances to ACQUIRE PHOTOS FROM OTHER SOURCES step 416, wherein photos (if available) are acquired from off-board databases via a wireless data connection (e.g., interface 308 of FIG. 28) or from onboard devices in the vehicle such as a laptop computer or personal digital assistant or cellular phone. Method 400 then advances to TIME DELAY step 418 and STOP PHOTOS step 420 wherein taking of further photos in step 412 is halted after the predetermined time delay of step 416 sufficient to insure, depending upon the photo interval then in use, that photos from the as-parked vehicle are included in the photos captured and stored in step 412. In step 420, the photos captured and stored in steps 412 and 416 (and optionally analyzed in step 412-1 if included), are then downloaded to the fob, i.e., any of the various fob embodiments. Download step 422 includes one or more of: (i) sub-step 422-1 wherein vehicle location information is downloaded, (ii) sub-step 422-2 wherein location quality data is downloaded (e.g., how reliable is the location data), (iii) sub-step 422-3 wherein the above-described photos are downloaded, and (iv) sub-step 422-4 where the results of photo analysis step 412-1 are downloaded. Following download step 422, method 400 returns to START 402 as shown by path 423. Method 400 insures that photo information concerning the vehicle environment will be downloaded to the fob under any circumstances independent of whether reliable location information is or is not available, and that if reliable location information is available the location information, location quality information and photo information will be downloaded to the fob. Thus, the present invention provides for multimode operation. Downloading location quality information is desirable but not essential.

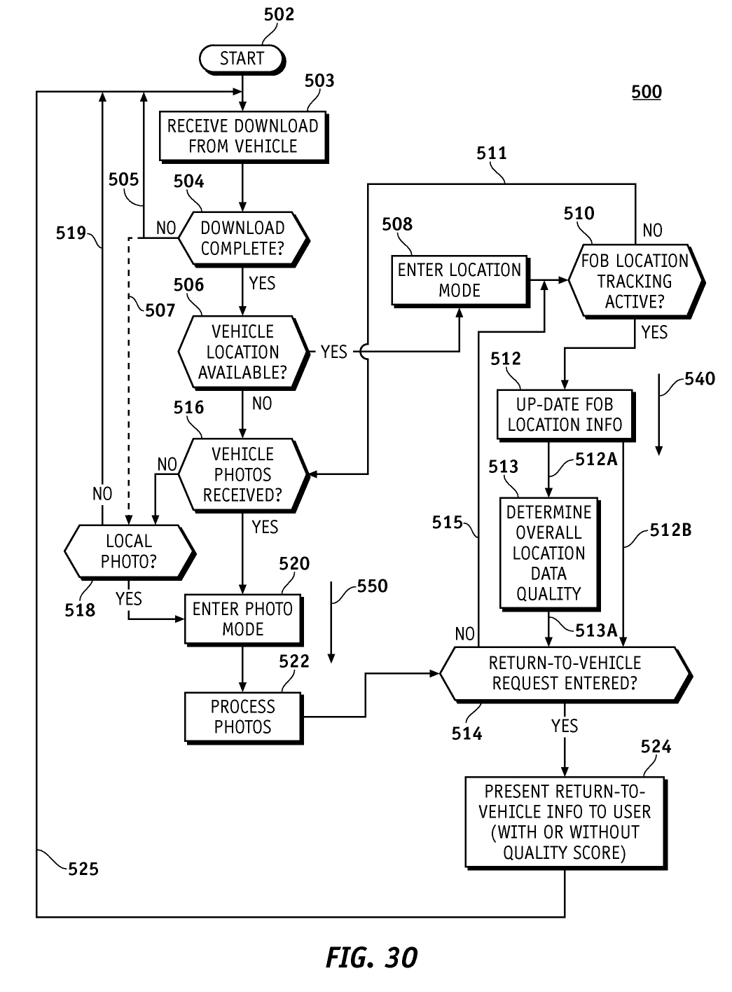

FIG. 30 is a flowchart illustrating exemplary process 500 utilized by device 200 (see FIG. 28) of the fobs illustrated in FIGS. 1-27 of the vehicle location system, to receive location, location quality and/or photo information from the vehicle and further process it and present RETURN-TO-VEHICLE (RTV) information when requested by the user. Method 500 begins with START 502 and initial RECEIVE DOWNLOAD step 503, wherein vehicle location, location quality and/or photo information is transferred from vehicle location portion or device 300 to fob device 200 using interface 310 of vehicle portion 300 and interface 210 of fob device 200. This should occur just after the vehicle is parked and before or just as the fob is being removed from the parked vehicle and is still in communication range of the vehicle. Query 504 is executed to confirm that the download is complete. If the outcome of query 504 is NO, then method 500 returns to START 502 as indicated by path 505 and loops until the download is complete. In an alternate embodiment, path 507 is used to check whether a local photograph taken by optional camera 41, 220 of the fob is available. If the outcome of query 504 is YES confirming that a download of location, location quality and/or photo information from the vehicle has been received and stored in memory 204 of fob device 200, then method 500 proceeds to query 506 wherein it is determined whether or not the download includes vehicle location information, as from step 422-1 of FIG. 29. If the outcome of query 506 is YES then method 500 proceeds to ENTER LOCATION MODE step 508, wherein fob device 200 attempts to develop RETURN TO VEHICLE (RTV) information based on using the now known vehicle location as a starting point and employing tracking systems 231 of FIG. 27 to provide updated fob locations as the user carries the fob away from the vehicle. Query 510 is provided to determine whether or not such location tracking capability (e.g., tracking system 231) within the fob is active, that is, able to provide further location information about the fob as it is carried by the user. If the outcome of query 510 is YES, then in step 512, the current fob location relative to the vehicle is updated using the output of one or more elements of fob tracking system 231. Method 500 then can proceed according to several embodiments as indicated by paths 512A, 512B. According to path 512A, method 500 proceeds to step 513 wherein the overall location quality is assessed. It will be understood by those of skill in the art based on the teachings herein, that the quality of the location information derived from step 512 depends upon both the quality of the location information downloaded from the vehicle and the quality of the location tracking (e.g., using fob tracking system 231) performed by the fob itself. For example, assuming that both the vehicle and the fob are using GPS tracking systems, the vehicle may be able to receive signals from 6-8 satellites and have a high quality GPS location solution (e.g., Q=4) while the fob itself may only be able to receive signals from fewer satellites and so have lower quality location tracking information (e.g., Q=2). In these circumstances, the overall location quality will degrade as the fob moves away from the vehicle so that the overall quality may only correspond to location information resolved by the fob itself, (e.g., overall Q=2-3) depending upon its distance from the vehicle. In any case, method 500 proceeds from step 512 via step 516 as shown by paths 512A, 513A or directly from step 512 to step 514 as shown by path 512B.

In query 514 it is determined whether or not a RETURN-TO-VEHICLE (RTV) request has been generated, e.g., by the user activating one or the other of buttons 23 and/or scroll wheel(s) 43 as has been previously described. If the outcome of query 514 is NO, then method 500 returns to query 510 to determine whether the fob location tracking capability is still active. The loop 510, 512, (513), 514 repeats as long as the fob location tracking capability is active, thereby continually updating the fob location information relative to the vehicle location. While step 513 is illustrated as occurring prior to step 514, this is not essential. Step 513 may be executed anytime prior to step 524.

If the outcome of query 510 is NO, for example, because fob location tracking system 231 is unable to receive the necessary signals or for whatever other reason, then method 500 proceeds to query 516 as shown by path 511. In query 516 it is determined whether or not vehicle environment photos have been received from the vehicle, e.g., via download steps 422-3, 422-4 of FIG. 29. If the outcome of query 516 is NO, then method 500 advances to query 518 wherein it is determined whether or not camera 41, 220 of fob system 200 was used to take a photo related to the parked vehicle location and store it in memory 204. If the outcome of query 518 is NO, indicating that no photos are available either from vehicle subsystem 300 or from fob system 200 and that no fob location information relative to the vehicle is available, then method 500 returns to START 502 as shown by path 519.

If the outcome of either query 516 or 518 is YES, then method 500 advances to ENTER PHOTO MODE step 520, wherein fob device 200 will make use of such photo information to assist the user in returning to the vehicle. This photo information, as for example but not intended to be limiting, from a photo obtained by keyfob camera 41, 2200, is desirably but not essentially analyzed in optional PROCESS PHOTOS step 522 to highlight features of the photo(s) that are particularly useful in guiding the user back to the vehicle. When the user enters a RETURN-TO-VEHICLE (RTV) request, that is, when the outcome of query 524 is YES, then system 200 presents the RETURN-TO-VEHICLE (RTV) information to the user in step 524. If the download included vehicle location information and one or more of fob location tracking elements 212, 214,216 of tracking system 231 are active, then method 500 (e.g. via path 540) presents this location information (and optionally location quality information), as for example is shown in FIGS. 1-5 and elsewhere. If the downloaded information does not include vehicle location information and/or none of fob location tracking elements 212, 214, 216 is able to provide updated fob locations relative to the vehicle, then method 500 (e.g., via path 550) will present the available photo information, as for example is shown in FIG. 4. If location (location quality) and photo information are available, then the combination can be presented as illustrated for example in FIG. 5. In either case, useful information is provided to the user to assist him or her in returning to the vehicle. If the vehicle and fob environments are such that both location information and photos are available to the fob, then both can be presented, as shown for example in FIG. 5. Thus, the invented arrangement and method is a multi-mode capable system and method, wherein the system and method automatically adapt to variations in the availability of, for example, GPS signals, and/or local beacon signals, and/or cell phone signals and/or dead reckoning capability and/or photo or map images to still provide assistance to the user in returning to his or her vehicle by means of timely stored photos from the location of the parked vehicle. This is a new and very useful capability. The results of this multimode approach are presented to the user on display 42, 66, 76 of fob 20, 60, 70, 80, 80′ or on screen 94, 108, 128, 138 of fob 90, 100, 120, 130 or by use of annunciator 59 or other output means well known in the art. Following PRESENT RTV INFORMATION TO THE USER step 524, method 500 returned to start 502 as shown by path 525.

In view of the above, it should be appreciated that a multi-mode parked vehicle location system and method have been provided that can not only operate various vehicle functions (e.g., LOCK, UN_LOCK, etc.) but also guide a user back to his or her vehicle. While able to use satellite signals or local beacon signals or cell phone signals if available, even in the absence of such signals, a photo capture feature and method is automatically or manually provided that makes RETURN-TO-VEHICLE (RTV) information available to the user. The capability to present larger display images by use of extendable/retractable displays and/or projection displays, allows greater information detail to be visually provided to the user. This is particularly important for RTV functions.

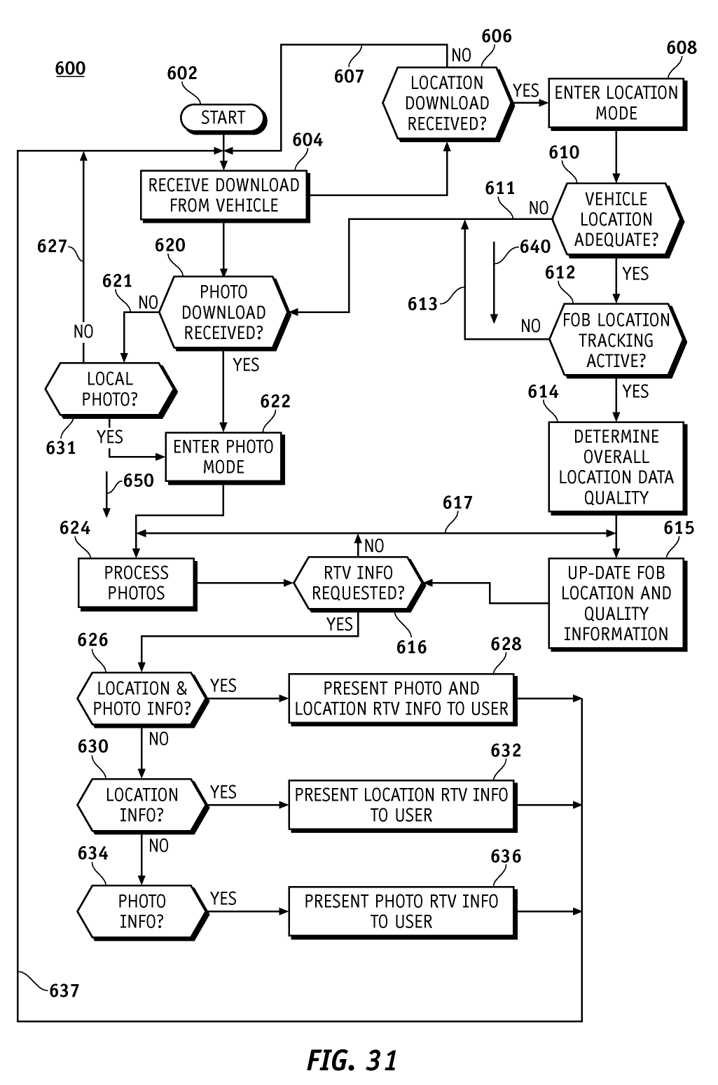

FIG. 31 is a flowchart illustrating exemplary method 600 analogous to that of FIG. 30, but according to additional embodiments of the invention and showing further details. Method 600 illustrates two pathways to providing return-to-vehicle (RTV) information to the user, path 640 where positional information provided by the vehicle and tracking information developed within the fob are used to provide location information in response to a RTV information request, and path 650 where photo information developed within the vehicle and/or the fob are used to provide RTV information in response to a RTV information request, or a combination of paths 640, 650 wherein both kinds of information are provided depending upon the nature of the user's RTV information request.

Method 600 begins with START 602 and initial step 604 wherein a download such as has been discussed in connection with FIG. 29 is received from the vehicle, for example, via interface 210 of FIG. 27 and interface 310 of FIG. 28. In query 606 it is determined whether the download of step 604 contains location information (and desirably also quality information). If the outcome of query 606 is NO, then method 600 loops back to START 602 as shown by path 607. If the outcome of query 606 is YES, then according to path 640, method 600 advances to ENTER LOCATION MODE step 608 and query 610 wherein the location and quality of the download information is examined to determine whether the vehicle location information is adequate, that is, sufficiently accurate for further processing in the fob to give a location based output to the user. If the outcome of query 610 is NO, indicating that the quality of the vehicle location information received from the vehicle download, is inadequate, them method 600 proceeds to PHOTO DOWNLOAD RECEIVED query 620 as shown by path 611, and location information path 640 (as opposed to photo information path 650) is abandoned. If the outcome of query 610 is YES, then method 600 proceeds to query 612 wherein it is determined whether or not one or more of the navigation or position locating elements 212, 214, and/or 216 (collectively tracking system 231 of FIG. 27) internal to the fob is active so as to be able to track the location of the fob relative to the vehicle position as the user carries it away. If the outcome of query 612 is NO, indicating that fob tracking system 231 is inoperative for whatever reason, then method 600 proceeds to PHOTO DOWNLOAD RECEIVED query 620 as shown by path 613, with the same result as by path 611. If the outcome of query 612 if YES indicating that the fob is able to use the initial position of the vehicle and subsequent movement of the fob to determine a current location of the fob in UP-DATE FOB LOCATION INFO step 615, with optional intervening overall quality determining step 614. The updated location and location quality information is then available when an RTV info request is received in query 616.

Returning again to DOWNLOAD step 604, method 600 proceeds to PHOTO DOWNLOAD RECEIVED query 620 wherein it is determined whether the vehicle has transmitted vehicle environment photo information to the fob. If the outcome of query 620 is NO, then method 600 proceeds to LOCAL PHOTO query 623 wherein it is determined whether or not a local photo from near the vehicle location has been taken by the user. If the outcome of query 623 is NO, indicating that no photo information either local or from the vehicle is available, then method 600 returns to start 602 s illustrated by path 627. If the outcome of query 620 or query 623 is YES, then method 600 proceeds to ENTER PHOTO MODE step 622 and optional PROCESS PHOTOS step 624 wherein generally the same type of processing described in connection with step 412-1 of FIG. 29 and/or step 522 of FIG. 30 is optionally performed. Method 600 then proceeds to RTV INFO REQUESTED query 616, the same destination that could be reached via path 640 from UP-DATE step 615.

Query 616 determines whether or not the user has asked for information on how to return to his or her vehicle. If the outcome of query 616 is NO, then method 600 returns to step 624 for photo information and step 615 for location information and method 600 cycles so as to maintain updated information until the outcome of query 616 is YES. When the outcome of query 616 is YES, then method 600 advances through queries 626, 630, 634 in any order, to determine what type of RTV information has been requested by the user. If the user has requested both location and photo information (query 626), then in step 628 photo and location information such as is illustrated for example in FIG. 5, is presented to the user on display 42, 66, 76, 97, 144, 222-1 or screen 94, 108, 128, 138 and/or annunciator 59 or a combination thereof. If location quality information is available, it is desirably included. If the user has requested only location information (query 630), then in step 632 only location (and location quality) information is presented such as is illustrated for example in FIGS. 1-5 to the user on display 42, 66, 76, 97, 144, 222-1 or screen 94, 108, 128, 138 or annunciator 59, light bar 45 and/or a combination thereof. If the user has requested only photo information (query 634), then in step 636 only photo information such as is illustrated for example in FIG. 4, is presented to the user on display 42, 66, 76, 97, 144, 222-1 or screen 94, 108, 128, 138 or a combination thereof. Following any of presentation steps 628, 632, 636 method 600 returns to START 602 as shown by path 637. In view of the above, it should be appreciated that a multi-mode parked vehicle location system and method, as well as a vehicle function control system, have been provided that can guide a user back to his or her vehicle. While able to use satellite signals or local beacon signals or cell phone signals if available, even in the absence of such signals, a photo capture feature and method is automatically or manually provided that makes RETURN-TO-VEHICLE (RTV) information available to the user. The capability to present larger display images by use of extendable/retractable displays and/or projection displays, allows greater information detail to be visually provided to the user. This is particularly important for RTV functions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any manner. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A portable electronic fob for interacting with a vehicle, comprising:
a controller adapted to manage operation of the fob;
a user input coupled to the controller and adapted to receive from the user a command to execute various functions involving the vehicle;
a wired or wireless communication element coupled to the controller for communicating with the vehicle; and
a projection display coupled to the controller and adapted to present to the user a visual image containing information about the vehicle status or the fob location relative to the vehicle or both.

2. The fob of claim 1, wherein the projection display is adapted to present the image on a surface exterior to the fob.

3. The fob of claim 2, wherein the projection display has a substantially straight optical path.

4. The fob of claim 1, further comprising:
a passive screen for receiving the image generated by the projection display, wherein the passive screen is carried within the fob and is extended from the fob when the image is to be viewed by the user and can be retracted into the fob for storage when viewing the image is not needed.

5. The fob of claim 4, wherein the passive screen is stored within the fob in a substantially flat configuration.

6. The fob of claim 4, wherein the passive screen is stored within the fob in a substantially rolled-up configuration.

7. The fob of claim 4, wherein the projection display comprises a laterally offset optical path.

8. The fob of claim 1, wherein the projection display is articulated so that, after being extended from the fob, it can be tilted toward the user for easier viewing.

9. A portable electronic fob for interacting with a vehicle, comprising:
a controller adapted to manage operation of the fob;
a user input coupled to the controller and adapted to receive from the user a command to execute various functions involving the vehicle;
a wired or wireless communication element coupled to the controller for communicating with the vehicle; and
a substantially direct view display coupled to the controller and adapted to present to the user a visual image containing information about the vehicle status or the fob location relative to the vehicle or both, wherein the display is moveable so as to be able to be stored within the fob or extended from the fob.

10. The fob of claim 9, wherein the display is stored within the fob in a substantially flat configuration.

11. The fob of claim 9, wherein the display is stored within the fob in a substantially rolled-up configuration.

12. The fob of claim 9, wherein the display is articulated so that, after extending it from the fob, it can be tilted toward the user for easier viewing.

13. The fob of claim 9, further comprising a navigation system for tracking the location of the fob as it moves away from the vehicle and communicating updated fob location information to the controller, so that the controller can combine such updated fob location information with vehicle location information received via the communication element and present on the display information on how the user may return to the vehicle.

14. The fob of claim 9, further comprising photo processing capability within the vehicle or fob, so that return-to-vehicle information presented to the user on the display can include photo information concerning the vehicle's immediate environment.

15. A portable electronic fob for interacting with a vehicle, comprising:
first and second portions coupled by a hinge, thereby forming a clam-shell configuration, wherein when the clam-shell configuration is closed the first and second portions are together and wherein the clam-shell configuration is opened by rotating the first and second portions around the hinge, and wherein the first portion has first and second opposed surfaces and the second portion has third and fourth opposed surfaces;
a controller within the first or second portions, adapted to manage operation of the fob;
a user input on the first surface of the first portion of the fob, coupled to the controller and adapted to receive from the user a command to execute various functions involving the vehicle;
a wired or wireless communication element within the first or second portions and coupled to the controller, for communicating with the vehicle; and
a substantially direct view display on the fourth surface of the second portion of the fob, coupled to the controller and adapted to present to the user a visual image containing information about the vehicle status or the fob location relative to the vehicle or both, when the clam-shell configuration is open.

16. The fob of claim 15, wherein in the closed position, the second and fourth surfaces are facing inner surfaces.

17. The fob of claim 15, wherein in the closed position, the first and fourth surfaces are facing inner surfaces.

18. The fob of claim 15, further comprising an axial pivot acting at right angles to a rotation axis of the hinge so that when the fob is in the open configuration, the first and second portions of the fob can rotate around the axial pivot so that the first and fourth surfaces then face in the same direction.

19. The fob of claim 15, wherein the image presented on the display includes a photographic image downloaded from the vehicle using the communication element.

20. The fob of claim 15, further comprising a navigation system for tracking the location of the fob as it moves away from the vehicle and communicating updated fob location information to the controller, so that the controller can combine such updated fob location information with vehicle location information received via the communication element and present on the display information on how the user may return to the vehicle.
